(19) United States
(12) Patent Application Publication
(10) Pub. No.: US 2020/0133630 A1
(43) Pub. Date: Apr. 30, 2020

(54) CONTROL APPARATUS, AGENT APPARATUS, AND COMPUTER READABLE STORAGE MEDIUM

(71) Applicant: HONDA MOTOR CO.,LTD., Tokyo (JP)

(72) Inventors: Toshikatsu KURAMOCHI, Tokyo (JP); Atsushi SEKIGUCHI, Saitama (JP)

(21) Appl. No.: 16/658,149

(22) Filed: Oct. 20, 2019

(30) Foreign Application Priority Data
Oct. 24, 2018 (JP) 2018-199654

(51) Int. Cl. G06F 3/16; G06F 3/01; H04L 29/08; G10L 13/04; G06T 13/80; G06F 3/0484; G06F 3/0481

(52) U.S. Cl. CPC G06F 3/167; G06F 3/017; H04L 67/36; G06F 3/0481; G06T 13/80; G06F 3/0484; G10L 13/043

(57) ABSTRACT

It is difficult to realize smooth communication between a user and an agent due to the communication environment of the user. Provided is a control apparatus that controls an agent apparatus functioning as a user interface of a first request processing apparatus that acquires a request indicated by at least one of a voice and a gesture of a user, via a communication network, and performs a process corresponding to the request, the control apparatus including a communication information acquiring section that acquires communication information indicating a communication state between the first request processing apparatus and the agent apparatus, and a mode determining section that determines a mode of an agent used to provide information by the agent apparatus, based on the communication state indicated by the communication information acquired by the communication information acquiring section.

### CROSS REFERENCE TO RELATED APPLICATION

The contents of the following Japanese patent application are incorporated herein by reference:

NO. 2018-199654 filed on Oct. 24, 2018.

### BACKGROUND

### 1. Technical Field

The present invention relates to a control apparatus, an agent apparatus, and a computer readable storage medium.

### 2. Related Art

An agent apparatus is known that executes various processes based on interactions with a user via an anthropomorphic agent, as shown in Patent Documents 1 and 2, for example.
Patent Document 1: Japanese Patent Application Publication No. 2006-189394
Patent Document 2: Japanese Patent Application Publication No. 2000-020888

### BRIEF DESCRIPTION OF THE DRAWINGS

FIG. 1 schematically shows an example of a system configuration of an interactive agent system 100.

FIG. 2 schematically shows an example of an internal configuration of the vehicle 110.

FIG. 3 schematically shows an example of an internal configuration of the input/output control section 272.

FIG. 4 schematically shows an example of an internal configuration of the request processing section 340.

FIG. 5 schematically shows an example of an internal configuration of the request determining section 420.

FIG. 6 schematically shows an example of an internal configuration of the response managing section 350.

FIG. 7 schematically shows an example of an internal configuration of the agent information storage section 360.

FIG. 8 schematically shows an example of an internal configuration of the support server 120.

FIG. 9 schematically shows an example of an internal configuration of the request determining section 842.

FIG. 10 schematically shows an example of a transition of the output mode of information.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention. In the drawings, identical or similar portions may be given the same reference numerals, and redundant descriptions may be omitted.

[Outline of an Interactive Agent System 100]

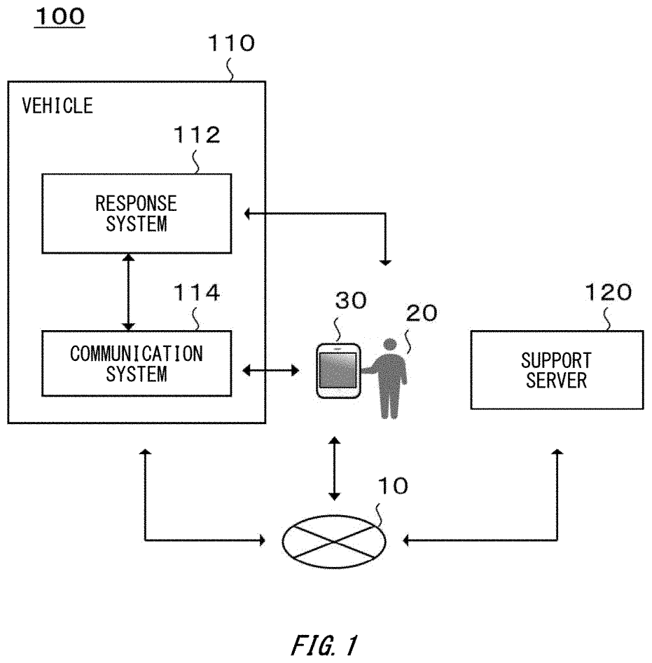

FIG. 1 schematically shows an example of a system configuration of an interactive agent system 100. In the present embodiment, the interactive agent system 100 includes a vehicle 110 and a support server 120. In the present embodiment, the vehicle 110 includes a response system 112 and a communication system 114.

The interactive agent system 100 may be an example of a first request processing apparatus and a second request processing apparatus. The first request processing apparatus and the second request processing apparatus may each be an example of a request processing apparatus. The vehicle 110 or a device mounted in the vehicle 110 may be an example of an agent apparatus. The response system 112 may be an example of an agent apparatus. The support server 120 may be an example of a first request processing apparatus.

In the present embodiment, the vehicle 110 and the support server 120 can transmit and receive information to and from each other via a communication network 10. Furthermore, the vehicle 110 and a communication terminal 30 used by a user 20 of the vehicle 110 may transmit and receive information to and from each other via the communication network 10, or the support server 120 and the communication terminal 30 may transmit and receive information to and from each other via the communication network 10.

In the present embodiment, the communication network 10 may be a wired communication transmission path, a wireless communication transmission path, or a combination of a wireless communication transmission path and a wired communication transmission path. The communication network 10 may include a wireless packet communication network, the Internet, a P2P network, a specialized network, a VPN, a power line communication network, or the like. The communication network 10 may include (i) a moving body communication network such as a mobile telephone network, (ii) a wireless communication network such as wireless MAN (e.g. WiMAX (registered trademark)), wireless LAN (e.g. WiFi (registered trademark)), Bluetooth (registered trademark), Zigbee (registered trademark), or NFC (Near Field Communication).

In the present embodiment, the user 20 may be a user of the vehicle 110. The user 20 may be the driver of the vehicle 110, or may be a passenger riding with this driver. The user 20 may be the owner of the vehicle 110, or may be an occupant of the vehicle 110. The occupant of the vehicle 110 may be a user of a rental service or sharing service of the vehicle 110.

In the present embodiment, the communication terminal 30 need only be able to transmit and receive information to and from at least one of the vehicle 110 and the support server 120, and the details of this are not particularly limited. Examples of the communication terminal 30 include a personal computer, a portable terminal, and the like. Examples of the portable terminal include a mobile telephone, a smartphone, a PDA, a tablet, a notebook computer or laptop computer, a wearable computer, and the like.

The communication terminal 30 may correspond to one or more communication systems. Examples of the communication system include a moving body communication system, a wireless MAN system, a wireless LAN system, a wireless PAN system, and the like. Examples of the moving body communication system include a GSM (registered trademark) system, a 3G system, an LTE system, a 4G system, a 5G system, and the like. Examples of the wireless MAN system include WiMAX (registered trademark). Examples of the wireless LAN system include WiFi (registered trademark). Examples of the wireless PAN system include Bluetooth (registered trademark), Zigbee (registered trademark), NFC (Near Field Communication), and the like.

In the present embodiment, the interactive agent system 100 acquires a request indicated by at least one of a voice or a gesture of the user 20, and executes a process corresponding to this request. Examples of the gesture include shaking the body, shaking a hand, behavior, face direction, gaze direction, facial expression, and the like. Furthermore, the interactive agent system 100 transmits the results of the above process to the user 20. The interactive agent system 100 may perform the acquisition of the request and transmission of the results described above via interactive instructions between the user 20 and an agent functioning as a user interface of the interactive agent system 100.

The agent is used to transmit information to the user 20. Not only linguistic information, but also non-linguistic information, can be transmitted through the interaction between the user 20 and the agent. Therefore, it is possible to realize smoother information transmission. The agent may be a software agent, or may be a hardware agent. There are cases where the agent is referred to as an A1 assistant.

The software agent may be an anthropomorphic agent realized by a computer. This computer may be a computer mounted in at least one of the communication terminal 30 and the vehicle 110. The anthropomorphic agent is displayed or projected on a display apparatus or projection apparatus of a computer, for example, and is capable of communicating with the user 20. The anthropomorphic agent may communicate with the user 20 by voice. The hardware agent may be a robot. The robot may be a humanoid robot, or a robot in the form of a pet.

The agent may have a face. The “face” may include not only a human or animal face, but also objects equivalent to a face. Objects equivalent to a face may be objects having the same functions as a face. Examples of the functions of a face include a function for communicating an emotion, a function for indicating a gaze point, and the like.

The agent may include eyes. The eyes include not only human or animal eyes, but also objects equivalent to eyes. Objects equivalent to eyes may be objects having the same functions as eyes. Examples of the functions of eyes include a function for communicating an emotion, a function for indicating a gaze point, and the like.

Here, “interaction” may include not only communication through linguistic information, but also communication through non-linguistic information. Examples of communication through linguistic information include (i) conversation, (ii) sign language, (iii), signals or signal sounds for which a gesture and the content to be communicated by this gesture are predefined, and the like. Examples of the communication through non-linguistic information include shaking the body, shaking a hand, behavior, face direction, gaze direction, facial expression, and the like.

In the present embodiment, the interactive agent system 100 includes an interaction engine (not shown in the drawings, and sometimes referred to as a local interaction engine) that is implemented in the response system 112 and an interaction engine (not shown in the drawings, and sometimes referred to as a cloud interaction engine) that is implement in the support server 120. In a case where the request from the user 20 is detected through voice recognition, gesture recognition, or the like, the interactive agent system 100 may determine which of the local interaction engine and the cloud interaction to use to respond to this request.

The local interaction engine and the cloud interaction engine may be physically different interaction engines. The local interaction engine and the cloud interaction engine may be interaction engines with different capabilities. In one embodiment, the number of types of requests that can be recognized by the local interaction engine is less than the number of types of requests that can be recognized by the cloud interaction engine. In another embodiment, the number of types of requests that can be processed by the local interaction engine is less than the number of types of requests that can be processes by the cloud interaction engine. The cloud interaction engine may be an example of a first request processing apparatus. The local interaction engine may be an example of a second request processing apparatus.

According to the present embodiment, the interactive agent system 100 determines which of the local interaction engine and the cloud interaction engine to use based on a communication state between the vehicle 110 and the support server 120. For example, in a case were the communication state is relatively good, the interactive agent system 100 responds to the request of the user 20 using the cloud interaction engine. On the other hand, if the communication state is relatively poor, the interactive agent system 100 responds to the request of the user 20 using the local interaction engine. In this way, it is possible to switch between the local interaction engine and the cloud interaction engine according to the communication state between the vehicle 110 and the support server 120.

The interactive agent system 100 may determine a mode of the agent based on a state of the response system 112. In this way, the mode of the agent can be switched according to the state of the response system 112. Examples of the state of the response system 112 include (i) a state in which the response system 112 is stopped (sometimes referred to as the OFF state), (ii) a state in which the response system 112 is operating (sometimes referred to as the ON state) and waiting (sometimes referred to as the standby state) to receive a request (sometimes referred to as an activation request) for staring the response process by the interaction engine, and (iii) a state where the response system 112 is in the ON state and executing the response process with the interaction engine (sometimes referred to as the active state).

The standby state may be a state for receiving an activation request and executing this activation request. The active state may be a state for processing a request other than the activation request, via the agent.

The activation request may be a request for activating the agent, a request for starting the response process via the agent, or a request for activating or enabling the voice recognition function or the gesture recognition function of the interaction engine. The activation request may be a request for changing the state of the response system 112 from the standby state to the active state. There are cases where the activation request is referred to as an activation word, trigger phrase, or the like. The activation request is not limited to a voice. The activation request may be a predetermined gesture or may be a manipulation for inputting the activation request.

At least one state of the response system 112 described above may be further refined. For example, the state in which the response process is executed by the interaction engine can be refined into a state in which the request of the user 20 is processed by the local interaction engine and a state in which the request of the user 20 is processed by the cloud interaction engine. In this way, as an example, the interactive agent system 100 can switch the mode of the agent between a case in which the local interaction engine processes the request of the user 20 and a case in which the cloud interaction engine processes the request of the user 20.

Examples of modes of the agent include at least one of the type of character used as the agent, the appearance of this character, the voice of this character, and the mode of interaction. Examples of the character include a character modeled on an actual person, animal, or object, a character modeled on a historic person, animal, or object, a character modeled on a fictional or imaginary person, animal, or object, and the like. The object may be a tangible object or an intangible object. The character may be a character modeled on a portion of the people, animals, or objects described above.

Examples of the appearance include at least one of (i) a form, pattern, color, or combination thereof, (ii) technique and degree of deformation, exaggeration, or alteration, and (iii) image style. Examples of the form include at least one of figure, hairstyle, clothing, accessories, facial expression, and posture. Examples of the deformation techniques include head-to-body ratio change, parts placement change, parts simplification, and the like. Examples of image styles include entire image color, touches, and the like. Examples of touches include photorealistic touches, illustration style touches, cartoon style touches, American comic style touches, Japanese comic style touches, serious touches, comedy style touches, and the like.

As an example, there are cases where the same character can have a different appearance due to age. The appearance of a character may differ between at least two of childhood, adolescence, young adulthood, middle age, old age, and twilight years. There are cases were the same character can have a different appearance as the degree of deformation progresses. For example, when two images of a character with the same appearance but different head-to-body ratios are compared to each other, the character in the image with the greater head-to-body ratio appears younger than the character in the image with the smaller head-to-body ratio.

Examples of the voice include at least one of voice quality, voice tone, and voice height (sometimes called pitch). Examples of the modes of interactions include at least one of the manner of speech and gesturing when responding. Examples of the manner of speech include at least one of voice volume, tone, tempo, length of each utterance, pauses, inflections, emphasis, how back-and-forth happens, habits, and how topics are developed. Specific examples of the manner of speech in a case where the interaction between the user 20 and the agent is realized through sign language may be the same as the specific examples of the manner of speech in a case where the interaction between the user 20 and the agent is realized through speech.

In general, the cloud interaction engine has greater functionality than the local interaction engine, and is also capable of processing a greater number of requests and has higher recognition accuracy. Therefore, when the communication state between the vehicle 110 and the support server 120 is worsened due to movement of the vehicle 110, communication interference between the vehicle 110 and the support server 120, or the like and the interaction engine is switched from the cloud interaction engine to the local interaction engine, the response quality drops. As a result, the user experience of the user 20 can also become worse.

According to the present embodiment, when the interaction engine is switched from the cloud interaction engine to the local interaction engine, the mode of the agent is also changed. Therefore, during the interaction with the agent, it is possible for the user 20 to sense and understand the current state of the agent. As a result, worsening of the user experience of the user 20 can be restricted.

In the present embodiment, the details of the interactive agent system 100 are described using an example of a case in which the response system 112 is an interactive vehicle driving support apparatus implemented in the vehicle 110. However, the interactive agent system 100 is not limited to the present embodiment. In another embodiment, the device in which the response system 112 is implemented is not limited to a vehicle. The response system 112 may be implemented in a stationary device, a mobile device (sometimes referred to as a moving body), or a portable or transportable device. The response system 112 is preferably implemented in a device that has a function for outputting information and a communication function. For example, the response system 112 can be implemented in the communication terminal 30. The device in which the response system 112 is implemented may be an example of the agent apparatus, a control apparatus, and the second request processing apparatus.

Examples of the stationary device include electronic appliances such as a desktop PC, a television, speakers, and a refrigerator. Examples of the mobile device include a vehicle, a work machine, a ship, and a flying object. Examples of the portable or transportable device include a mobile telephone, a smartphone, a PDA, a tablet, a notebook computer or laptop computer, a wearable computer, a mobile battery, and the like.

[Outline of Each Section of the Interactive Agent System 100]

In the present embodiment, the vehicle 110 is used to move the user 20. Examples of the vehicle 110 include an automobile, a motorcycle, and the like. Examples of a motorcycle include (i) a motorbike, (ii), a three-wheeled motorcycle, (iii) a standing motorcycle including a power unit, such as a Segway (registered trademark), a kickboard (registered trademark) with a power unit, a skateboard with a power unit, and the like.

In the present embodiment, the response system 112 acquires a request indicated by at least one of the voice and a gesture of the user 20. The response system 112 executes a process corresponding to this request. Furthermore, the response system 112 transmits the result of this process to the user 20.

In one embodiment, the response system 112 acquires a request input by the user 20 to a device mounted in the vehicle 110. The response system 112 provides the user 20 with a response to this request, via the device mounted in the vehicle 110. In another embodiment, the response system 112 acquires, via the communication system 114, a request input by the user 20 to a device mounted in the communication terminal 30. The response system 112 transmits the response to this request to the communication terminal 30, via the communication system 114. The communication terminal 30 provides the user 20 with the information acquired from the response system 112.

In one embodiment, the response system 112 acquires (i) a request input by the user 20 to the device mounted in the vehicle 110 or (ii) a request input by the user 20 to the device mounted in the communication terminal 30. The response system 112 may acquire, via the communication system 114, the request input by the user 20 to the device mounted in the communication terminal 30. The response system 112 may provide the user 20 with the response to this request via an information input/output device mounted in the vehicle 110.

In another embodiment, the response system 112 acquires (i) a request input by the user 20 to the device mounted in the vehicle 110 or (ii) a request input by the user 20 to the device mounted in the communication terminal 30. The response system 112 may acquire, via the communication system 114, the request input by the user 20 to the device mounted in the communication terminal 30. The response system 112 transmits the response to this request to the communication terminal 30, via the communication system 114. The communication terminal 30 provides the user 20 with the information acquired from the response system 112.

The response system 112 may function as a user interface of the local interaction engine. The response system 112 may function as a user interface of the cloud interaction engine.

In the present embodiment, the communication system 114 communicates information between the vehicle 110 and the support server 120, via the communication network 10. The communication system 114 may communicate information between the vehicle 110 and the communication terminal 30 using wired communication or short-range wireless communication.

As an example, the communication system 114 transmits to the support server 120 information concerning the user 20 acquired by the response system 112 from the user 20. The communication system 114 may transmit, to the support server 120, information concerning the user 20 acquired by the communication terminal 30 from the user 20. The communication system 114 may acquire information concerning the vehicle 110 from the device mounted in the vehicle 110, and transmit the information concerning the vehicle 110 to the support server 120. The communication system 114 may acquire information concerning the communication terminal 30 from the communication terminal 30, and transmit the information concerning the communication terminal 30 to the support server 120.

Furthermore, the communication system 114 receives, from the support server 120, information output by the cloud interaction engine. The communication system 114 transmits, to the response system 112, the information output by the cloud interaction engine. The communication system 114 may transmit the information output by the response system 112 to the communication terminal 30.

In the present embodiment, the support server 120 executes a program causing a computer of the support server 120 to function as the cloud interaction engine. In this way, the cloud interaction engine operates on the support server 120.

In the present embodiment, the support server 120 acquires a request indicated by at least one of the voice and a gesture of the user 20, via the communication network 10. The support server 120 executes a program corresponding to this request. Furthermore, the support server 120 notifies the response system 112 about the results of this process, via the communication network 10.

[Detailed Configuration of Each Section of the Interactive Agent System 100]

Each section of the interactive agent system 100 may be realized by hardware, by software, or by both hardware and software. At least part of each section of the interactive agent system 100 may be realized by a single server or by a plurality of servers. At least part of each section of the interactive agent system 100 may be realized on a virtual server or a cloud system. At least part of each section of the interactive agent system 100 may be realized by a personal computer or a mobile terminal The mobile terminal can be exemplified by a mobile telephone, a smart phone, a PDA, a tablet, a notebook computer, a laptop computer, a wearable computer, or the like. Each section of the interactive agent system 100 may store information, using a distributed network or distributed ledger technology such as block chain.

If at least some of the components forming the interactive agent system 100 are realized by software, these components realized by software may be realized by starting up programs in which operations corresponding to these components are defined, with an information processing apparatus having a general configuration. The information processing apparatus having the general configuration described above may include (i) a data processing apparatus having a processor such as a CPU or a GPU, a ROM, a RAM, a communication interface, and the like, (ii) an input apparatus such as a keyboard, a touch panel, a camera, a microphone, various sensors, or a GPS receiver, (iii) an output apparatus such as a display apparatus, an voice output apparatus, or a vibration apparatus, and (iv) a storage apparatus (including an external storage apparatus) such as a memory or an HDD.

In the information processing apparatus having the general configuration described above, the data processing apparatus or the storage apparatus described above may store the programs described above. The programs described above may be stored in a non-transitory computer readable storage medium. The programs described above cause the information processing apparatus described above to perform the operations defined by these programs, by being executed by the processor.

The programs may be stored in a non-transitory computer readable storage medium. The programs may be stored in a computer readable medium such as a CD-ROM, a DVD-ROM, a memory, or a hard disk, or may be stored in a storage apparatus connected to a network. The programs described above may be installed in the computer forming at least part of the interactive agent system 100, from the computer readable medium or the storage apparatus connected to the network. The computer may be caused to function as at least a portion of each section of the interactive agent system 100, by executing the programs described above.

The programs that cause the computer to function as at least some of the sections of the interactive agent system 100 may include modules in which the operations of the sections of the interactive agent system 100 are defined. These programs and modules act on the data processing apparatus, the input apparatus, the output apparatus, the storage apparatus, and the like to cause the computer to function as each section of the interactive agent system 100 and to cause the computer to perform the information processing method in each section of the interactive agent system 100.

By having the computer read the programs described above, the information processes recorded in these programs function as the specific means realized by the cooperation of software relating to these programs and various hardware resources of some or all of the interactive agent system 100. These specific means realize computation or processing of the information corresponding to an intended use of the computer in the present embodiment, thereby forming the interactive agent system 100 corresponding to this intended use.

[Outline of Each Section of the Vehicle 110]

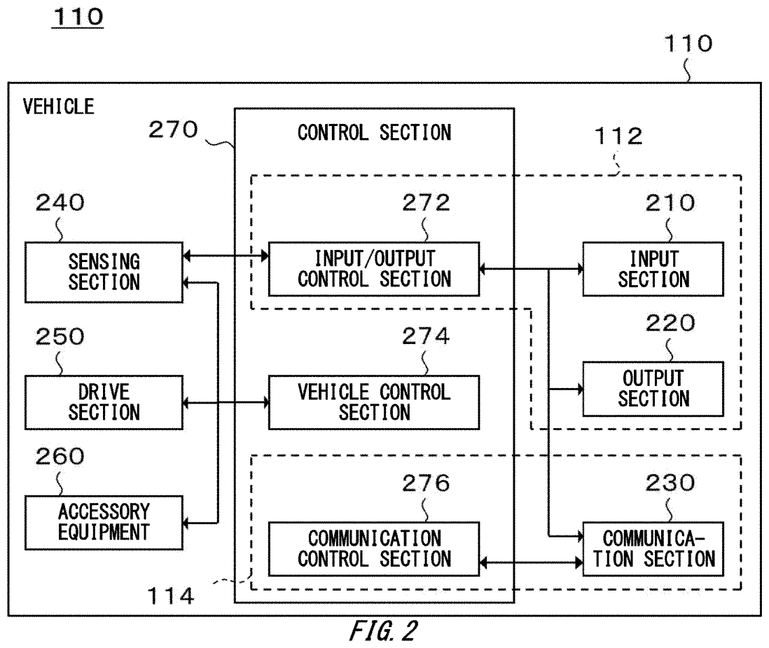

FIG. 2 schematically shows an example of an internal configuration of the vehicle 110. In the present embodiment, the vehicle 110 includes an input section 210, an output section 220, a communicating section 230, a sensing section 240, a drive section 250, accessory equipment 260, and a control section 270. In the present embodiment, the control section 270 includes an input/output control section 272, a vehicle control section 274, and a communication control section 276. In the present embodiment, the response system 112 is formed by the input section 210, the output section 220, and the input/output control section 272. Furthermore, the communication system 114 is formed by the communicating section 230 and the communication control section 276.

The input section 210 may be an example of an input section. The output section 220 may be an example of an agent output section. The control section 270 may be an example of the control apparatus and the second request processing apparatus. The input/output control section 272 may be an example of the control apparatus.

In the present embodiment, the input section 210 receives the input of information. For example, the input section 210 receives the request from the user 20. The input section 210 may receive the request from the user 20 via the communication terminal 30.

In one embodiment, the input section 210 receives a request concerning manipulation of the vehicle 110. Examples of the request concerning manipulation of the vehicle 110 include a request concerning manipulation or setting of the sensing section 240, a request concerning manipulation or setting of the drive section 250, a request concerning manipulation or setting of the accessory equipment 260, and the like. Examples of the request concerning setting include a request for changing a setting, a request for checking a setting, and the like. In another embodiment, the input section 210 receives a request indicated by at least one of the voice and a gesture of the user 20.

Examples of the input section 210 include a keyboard, a pointing device, a touch panel, a manipulation button, a microphone, a camera, a sensor, a three-dimensional scanner, a gaze measuring instrument, a handle, an acceleration pedal, a brake, a shift bar, and the like. The input section 210 may form a portion of the navigation apparatus.

In the present embodiment, the output section 220 outputs information. For example, the output section 220 provides the user 20 with the response made by the interactive agent system 100 to the request from the user 20. The output section 220 may provide the user 20 with this response via the communication terminal 30. Examples of the output section 220 include an image output apparatus, a voice output apparatus, a vibration generating apparatus, an ultrasonic wave generating apparatus, and the like. The output section 220 may form a portion of the navigation apparatus.

The image output apparatus displays or projects an image of the agent. The image may be a still image or a moving image (also referred to as video). The image may be a flat image or a stereoscopic image. The method for realizing a stereoscopic image is not particularly limited, and examples thereof include a binocular stereo method, an integral method, a holographic method, and the like.

Examples of the image output apparatus include a display apparatus, a projection apparatus, a printing apparatus, and the like. Examples of the voice output apparatus include a speaker, headphones, earphones, and the like. The speaker may have directivity, and may have a function to adjust or change the orientation of the directivity.

In the present embodiment, the communicating section 230 communicates information between the vehicle 110 and the support server 120, via the communication network 10. The communicating section 230 may communicate information between the vehicle 110 and the communication terminal 30 using wired communication or short-range wireless communication. The communicating section 230 may correspond to one or more communication methods.

In the present embodiment, the sensing section 240 includes one or more sensors that detect or monitor the state of the vehicle 110. At least some of one or more sensing sections 240 may be used as the input section 210. Each of the one or more sensors may be any internal field sensor or any external field sensor. For example, the sensing section 240 may include at least one of a camera that captures an image of the inside of the vehicle 110, a microphone that gathers sound inside the vehicle 110, a camera that captures an image of the outside of the vehicle 110, and a microphone that gathers sound outside the vehicle 110. These cameras and microphones may be used as the input section 210.

Examples of the state of the vehicle 110 include velocity, acceleration, tilt, vibration, noise, operating status of the drive section 250, operating status of the accessory equipment 260, operating status of a safety apparatus, operating status of an automatic driving apparatus, abnormality occurrence status, current position, movement route, outside air temperature, outside air humidity, outside air pressure, internal space temperature, internal space humidity, internal space pressure, position relative to surrounding objects, velocity relative to surrounding objects, and the like. Examples of the safety apparatus include an ABS (Antilock Brake System), an airbag, an automatic brake, an impact avoidance apparatus, and the like.

In the present embodiment, the drive section 250 drives the vehicle 110. The drive section 250 may drive the vehicle 110 according to a command from the control section 270. The drive section 250 may generate power using an internal combustion engine, or may generate power using an electrical engine.

In the present embodiment, the accessory equipment 260 may be a device other than the drive section 250, among the devices mounted in the vehicle 110. The accessory equipment 260 may operate according to a command from the control section 270. The accessory equipment 260 may operate according to a manipulation made by the user 20. Examples of the accessory equipment 260 include a security device, a seat adjustment device, a lock management device, a window opening and closing device, a lighting device, an air conditioning device, a navigation device, an audio device, a video device, and the like.

In the present embodiment, the control section 270 controls each section of the vehicle 110. The control section 270 may control the response system 112. The control section 270 may control the communication system 114. The control section 270 may control at least one of the input section 210, the output section 220, the communicating section 230, the sensing section 240, the drive section 250, and the accessory equipment 260. Furthermore, the sections of the control section 270 may transmit and receive information to and from each other.

In the present embodiment, the input/output control section 272 controls the input and output of information in the vehicle 110. For example, the input/output control section 272 controls the transmission of information between the user 20 and the vehicle 110. The input/output control section 272 may control the operation of at least one of the input section 210 and the output section 220. The input/output control section 272 may control the operation of the response system 112.

As an example, the input/output control section 272 acquires information including the request from the user 20, via the input section 210. The input/output control section 272 determines the response to this request. The input/output control section 272 may determine at least one of the content and the mode of the response. The input/output control section 272 outputs information concerning this response. In one embodiment, the input/output control section 272 provides the user 20 with information including this response, via the output section 220. In another embodiment, the input/output control section 272 transmits the information including this response to the communication terminal 30, via the communicating section 230. The communication terminal 30 provides the user 20 with the information including this response.

The input/output control section 272 may determine the response to the above request using at least one of the local interaction engine and the cloud interaction engine. In this way, the input/output control section 272 can cause the response system 112 to function as the user interface of the local interaction engine. Furthermore, the input/output control section 272 can cause the response system 112 to function as the user interface of the cloud interaction engine.

The input/output control section 272 determines whether to respond based on the execution results of the process by the local interaction engine or of the process by the cloud interaction engine, based on the information (also referred to as communication information) indicating the communication state between the vehicle 110 and the support server 120. The input/output control section 272 may use a plurality of local interaction engines or may use a plurality of cloud interaction engines. In this case, the input/output control section 272 may determine which interaction engine's process execution results the response is to be based on, based at least the communication information. The input/output control section 272 may determine which interaction engine's process execution results the response is to be based on, according to the speaker or the driver. The input/output control section 272 may determine which interaction engine's process execution results the response is to be based on, according to the presence or lack of a passenger.

In one embodiment, the input/output control section 272 determines the interaction engine to processes the request from the user 20 based on the communication information. In this case, one of the local interaction engine and the cloud interaction engine processes the request from the user 20, and the other does not process the request from the user 20.

In another embodiment, the local interaction engine and the cloud interaction engine each execute the process corresponding to the request from the user 20 and output, to the input/output control section 272, information that is a candidate for the response to this request. The input/output control section 272 uses one or more candidates acquired within a predetermined interval to determine the response to the request from the user 20. For example, the input/output control section 272 determines the response to the request from the user 20, from among one or more candidates, according to a predetermined algorithm.

Information indicating whether the input/output control section 272 has received the execution results of the process in the cloud interaction engine operating on the support server 120, within a predetermined interval after the input/output control section 272 or the interaction engine has received the request from the user 20, may be an example of the communication information. For example, in a case where the input/output control section 272 cannot receive the execution results of the process in the cloud interaction engine within the predetermined interval after the request from the user 20 has been received, the input/output control section 272 can judge that the communication state between the vehicle 110 and the support server 120 is not good.

The input/output control section 272 acquires the communication information from the communication control section 276, for example. The communication information may be (i) information indicating the communication state between the communicating section 230, the input/output control section 272, or the communication control section 276 and the support server 120, (ii) information indicating the communication state between the communicating section 230, the input/output control section 272, or the communication control section 276 and the communication network 10, (iii) information indicating the communication state of the communication network 10, (iv) information indicating the communication state between the communication network 10 and the support server 120, or (iv) information indicating the presence or lack of communication obstruction in at least one of the vehicle 110 and the support server 120.

The input/output control section 272 may detect the occurrence of one or more events, and control the operation of the response system 112 based on the type of the detected event. In one embodiment, the input/output control section 272 detects the input of an activation request. When input of the activation request is detected, the input/output control section 272 determines that the state of the response system 112 is to be changed from the standby state to the active state, for example.

In another embodiment, the input/output control section 272 detects the occurrence of an event for which a message is to be transmitted to the communication terminal 30 of the user 20 (sometimes referred to as a message event). When the occurrence of a message event is detected, the input/output control section 272 determines that a voice message is to be transmitted to the communication terminal 30 of the user 20, via the communication network 10, for example.

The input/output control section 272 may control the mode of the agent when responding to the request from the user 20. In one embodiment, the input/output control section 272 controls the mode of the agent based on the communication information. For example, the input/output control section 272 switches the mode of the agent between a case where the communication state between the vehicle 110 and the support server 120 satisfies a predetermined condition and a case where the communication state between the vehicle 110 and the support server 120 does not satisfy this predetermined condition. The predetermined condition may be a condition such as the communication state being better than a predetermined specified state.

In another embodiment, the input/output control section 272 controls the mode of the agent based on information indicating the interaction engine that processed the request from the user 20. For example, the input/output control section 272 switches the mode of the agent between a case where the response is made based on the execution results of the process in the local interaction engine and a case where the response is made based on the execution results of the process in the cloud interaction engine. As described above, the determination concerning which interaction engines' process execution results the response is to be based on is made based on the communication information.

In another embodiment, the input/output control section 272 controls the mode of the agent based on at least one of (i) information indicating a transmission means of the request of the user 20, (ii) information indicating how the user 20 communicated the request, and (iii) information indicating at least one of a psychological state, a wakefulness state, and a health state of the user 20 at the time the request is transmitted. Examples of the communication means of the request include an utterance, sign language, a gesture other than sign language, and the like. Examples of gestures other than sign language include a signal defined by moving a hand or finger, a signal defined by moving the head, a signal defined by line of sight, a signal defined by a facial expression, and the like.

Examples of how the request is communicated include the condition of the user 20 when the request is transmitted, the amount of time needed to transmit the request, the degree of clarity of the request, and the like. Examples of the condition of the user 20 when the request is transmitted include (i) the tone, habit, tempo, and pauses in the utterances or sign language, (ii) the accent, intonation, and voice volume of the utterances, (iii) the relative positions of the user and the output section 220 or the agent, and (iv) the position of the gazing point. Examples of the degree of clarity of the request include whether the request was transmitted to the end, whether a message for transmitting the request is redundant, and the like.

In yet another embodiment, the input/output control section 272 controls the mode of the agent based on information indicating the state of the vehicle 110. The state of the vehicle 110 may be at least one of the movement state of the vehicle 110, the operational state of each section of the vehicle 110, and the state of the internal space of the vehicle 110.

Examples of the movement state of the vehicle 110 include a current position, a movement route, velocity, acceleration, tilt, vibration, noise, presence or lack and degree of traffic, continuous driving time, presence or lack and frequency of sudden acceleration, presence or lack and frequency of sudden deceleration, and the like. Examples of the operational state of each section of the vehicle 110 include the operating status of the drive section 250, the operating status of the accessory equipment 260, the operating status of the safety apparatus, the operating status of the automatic driving apparatus, and the like. Examples of the operating status include normal operation, stopped, maintenance, abnormality occurring, and the like. The operational status may include the presence or lack and frequency of the operation of a specified function.

Examples of the state of the internal space of the vehicle 110 include the temperature, humidity, pressure, or concentration of a specified chemical substance in the internal space, the number of users 20 present in the internal space, the personal relationships among the users 20 present in the internal space, and the like. The information concerning the number of users 20 in the internal space may be an example of information indicating the presence or lack of passengers.

In the present embodiment, the vehicle control section 274 controls the operation of the vehicle 110. For example, the vehicle control section 274 acquires the information output by the sensing section 240. The vehicle control section 274 may control the operation of at least one of the drive section 250 and the accessory equipment 260. The vehicle control section 274 may control the operation of at least one of the drive section 250 and the accessory equipment 260, based on the information output by the sensing section 240.

In the present embodiment, the communication control section 276 controls the communication between the vehicle 110 and an external device. The communication control section 276 may control the operation of the communicating section 230. The communication control section 276 may be a communication interface. The communication control section 276 may correspond to one or more communication methods. The communication control section 276 may detect or monitor the communication state between the vehicle 110 and the support server 120. The communication control section 276 may generate the communication information, based on the result of this detection or monitoring.

Examples of the communication information include information concerning communication availability, radio wave status, communication quality, type of communication method, type of communication carrier, and the like. Examples of the radio wave status include radio wave reception level, radio wave strength, RSCP (Received Signal Code Power), CID (Cell ID), and the like. Examples of the communication quality include communication speed, data communication throughput, data communication latency, and the like.

Concerning the communication availability, communication is judged to be impossible (sometimes referred to as communication being unavailable) when communication obstruction occurs in at least one of the communication network 10, the communication system 114, and the support server 120. The communication may be judged to be unavailable when the radio wave reception level is less than a predetermined level (e.g. when out of service range). The communication availability may be judged based on results obtained by repeatedly performing a process (also referred to as test) to acquire information concerning a specified radio wave status or communication quality.

According to one embodiment, the communication is judged to be possible (also referred to as communication being available) when a ratio of the tests indicating that the radio wave status or communication quality is better than a predetermined first threshold, among a predetermined number of tests, is greater than a predetermined second threshold value. In any other case, communication is judged to be unavailable. According to another embodiment, the communication is judged to be unavailable when a ratio of the tests indicating that the radio wave status or communication quality is worse than a predetermined first threshold, among a predetermined number of tests, is greater than a predetermined second threshold value. In any other case, communication is judged to be available.

[Outline of Each Section of the Input/Output Control Section 272]

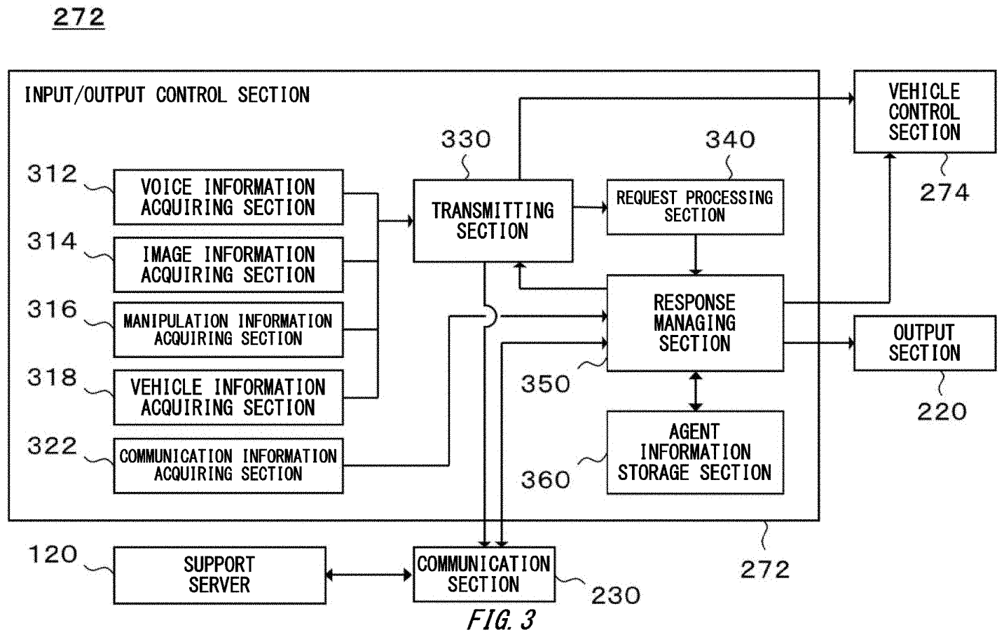

FIG. 3 schematically shows an example of an internal configuration of the input/output control section 272. In the present embodiment, the input/output control section 272 includes a voice information acquiring section 312, an image information acquiring section 314, a manipulation information acquiring section 316, a vehicle information acquiring section 318, a communication information acquiring section 322, a transmitting section 330, a request processing section 340, a response managing section 350, and an agent information storage section 360.

The communication information acquiring section 322 may be an example of a communication information acquiring section. The request processing section 340 may be an example of the second request processing apparatus. The response managing section 350 may be an example of a mode determining section and a processing apparatus determining section.

In the present embodiment, the voice information acquiring section 312 acquires, from the input section 210, information (sometimes referred to as voice information) concerning a voice input to the input section 210. The voice information acquiring section 312 may acquire, via the communicating section 230, information (sometimes referred to as voice information) concerning a voice input to an input apparatus of the communication terminal 30. For example, the voice information acquiring section 312 acquires information concerning the voice of the user 20. Examples of voice information include voice data in which the voice is recorded, information indicating the timing at which this voice was recorded, and the like. The voice information acquiring section 312 may output the voice information to the transmitting section 330.

In the present embodiment, the image information acquiring section 314 acquires, from the input section 210, information (sometimes referred to as image information) concerning an image acquired by the input section 210. The image information acquiring section 314 may acquire, via the communicating section 230, information (sometimes referred to as image information) concerning an image acquired by an input apparatus of the communication terminal 30. For example, the image information acquiring section 314 acquires information concerning an image obtained by capturing an image of the user 20. Examples of the image information include image data in which an image is recorded, information indicating the timing at which the image was recorded, and the like. The image information acquiring section 314 may output the image information to the transmitting section 330.

In the present embodiment, the manipulation information acquiring section 316 acquires, from the input section 210, information (sometimes referred to as manipulation information) concerning a manipulation of the vehicle 110 by the user 20. Examples of the manipulation of the vehicle 110 include at least one of a manipulation concerning the drive section 250 and a manipulation concerning the accessory equipment 260. In one embodiment, the manipulation information acquiring section 316 outputs the manipulation to the transmitting section 330. In another embodiment, the manipulation information acquiring section 316 outputs the manipulation information to the vehicle control section 274.

Examples of the manipulation concerning the drive section 250 include handle manipulation, acceleration pedal manipulation, brake manipulation, manipulation concerning a change of the driving mode, and the like. Examples of the manipulation concerning the accessory equipment 260 include manipulation concerning turning the accessory equipment 260 ON/OFF, manipulation concerning setting of the accessory equipment 260, manipulation concerning operation of the accessory equipment 260, and the like. More specific examples include manipulation concerning a direction indicating device, manipulation concerning a wiper, manipulation concerning the ejection of window washing fluid, manipulation concerning door locking and unlocking, manipulation concerning window opening and closing, manipulation concerning turning an air conditioner or lighting device ON/OFF, manipulation concerning setting of the air conditioner or lighting device, manipulation concerning turning a navigation device, audio device, or video device ON/OFF, manipulation concerning setting of the navigation device, audio device, or video device, manipulation concerning the starting or stopping the operation of the navigation device, audio device, or video device, and the like.

In the present embodiment, the vehicle information acquiring section 318 acquires, from the sensing section 240, information (sometimes referred to as vehicle information) indicating the state of the vehicle 110. In one embodiment, the vehicle information acquiring section 318 outputs the vehicle information to the transmitting section 330. In another embodiment, the vehicle information acquiring section 318 may output the vehicle information to the vehicle control section 274.

In the present embodiment, the communication information acquiring section 322 acquires the communication information from the communication control section 276. In one embodiment, the communication information acquiring section 322 outputs the communication information to the response managing section 350. In another embodiment, the communication information acquiring section 322 may output the communication information to the transmitting section 330 or request processing section 340.

In the present embodiment, the transmitting section 330 transmits at least one of the voice information, the image information, the manipulation information, and the vehicle information to at least one of the request processing section 340 and the support server 120. The transmitting section 330 may determine the transmission destination of each type of information according to commands from the response managing section 350. The transmitting section 330 may transmit the manipulation information to the vehicle control section 274. The transmitting section 330 may transmit the manipulation information and the vehicle information to the vehicle control section 274.

In the present embodiment, the details of the input/output control section 272 are described using an example of a case in which the communication information acquiring section 322 outputs the communication information to the response managing section 350 and the response managing section 350 determines the transmission destination of the voice information, the image information, the manipulation information, the vehicle information, and the like based on the communication information. However, the input/output control section 272 is not limited to the present embodiment. In another embodiment, the communication information acquiring section 322 may output the communication information to the transmitting section 330, and the transmitting section 330 may determine the transmission destination of the voice information, the image information, the manipulation information, the vehicle information, and the like based on the communication information.

In the present embodiment, the request processing section 340 acquires a request from the user 20 and executes a process corresponding to this request. The request processing section 340 determines a response to this request. For example, the request processing section 340 determines at least one of the content and the mode of the response. The request processing section 340 generates information concerning the response, based on the result of the above determination. The request processing section 340 outputs the information concerning the response to the response managing section 350.

The request processing section 340 may detect an activation request. When an activation request is detected, the request processing section 340 may output information indicating that the activation request has been detected to the response managing section 350. Due to this, the response process is started in the response system 112. The request processing section 340 may be an example of the local interaction engine. The details of the request processing section 340 are described further below.

In the present embodiment, the details of the request processing section 340 are described using an example of a case in which the request processing section 340 acquires the request indicated by the voice or a gesture of the user 20 input to the input section 210, using wired communication or short-range wireless communication, and executes a process corresponding to this request. However, the request processing section 340 is not limited to the present embodiment. In another embodiment, the request processing section 340 acquires the request indicated by the voice or a gesture of the user 20 input to the input apparatus of the communication terminal 30, using wired communication or short-range wireless communication, and executes a process corresponding to this request. In this case, the communication terminal 30 may form a portion of the response system 112.

Furthermore, in the present embodiment, the details of the request processing section 340 are described using an example of a case in which the request processing section 340 is arranged in the vehicle 110. However, the request processing section 340 is not limited to the present embodiment. In another embodiment, the request processing section 340 may be arranged in the communication terminal 30. In this case, the communication terminal 30 may form a portion of the response system 112.

In the present embodiment, the response managing section 350 manages the responses to the requests from the user 20. The response managing section 350 may manage the usage of the local interaction engine and the cloud interaction engine. For example, the response managing section 350 controls the operation of the transmitting section 330 to manage the usage of the local interaction engine and the cloud interaction engine. The response managing section 350 may manage at least one of the content and the mode of a response.

As an example, in a case where the request from the user 20 is a request concerning a search or investigation, the response managing section 350 manages the content of the response message output from the output section 220. The response managing section 350 may manage the mode of the agent at the time when the agent outputs the response message. The response managing section 350 may reference the information stored in the agent information storage section 360 to generate at least one of the voice and an image to be output from the output section 220. In a case where the request from the user 20 is a request concerning control of the vehicle 110, the response managing section 350 may output a command for controlling the vehicle 110 to the vehicle control section 274 in response to this request. The details of the response managing section 350 are described further below.

In the present embodiment, the agent information storage section 360 stores each type of information concerning the agent. The details of the agent information storage section 360 are described further below.

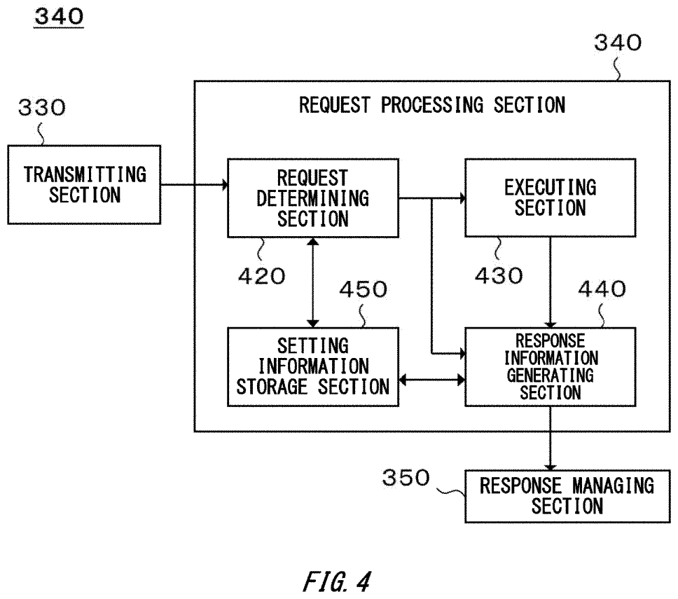

FIG. 4 schematically shows an example of an internal configuration of the request processing section 340. In the present embodiment, the request processing section 340 include a request determining section 420, an executing section 430, a response information generating section 440, and a setting information storage section 450.

According to the present embodiment, in order to facilitate understanding, the details of the request processing section 340 are described using an example of a case in which the request processing section 340 is configured to recognize requests of one or more predetermined types and to not recognize other requests. A request that can be recognized by the request processing section 340 may be a request corresponding to a process that can be handled by the request processing section 340.

According to the present embodiment, in order to facilitate understanding, the details of the request processing section 340 are described using an example of a case in which the request processing section 340 handles processes that do not use the communication network 10 but does not handle processes that use the communication network 10. As an example, the request processing section 340 handles a process concerning manipulation of the vehicle 110, but does not handle a process for searching for information on the Internet.

In the present embodiment, the request determining section 420 acquires at least one of the voice information acquired by the voice information acquiring section 312 and the image information acquired by the image information acquiring section 314, via the transmitting section 330. The request determining section 420 may acquire at least one of the voice information acquired by the voice information acquiring section 312, the image information acquired by the image information acquiring section 314, the manipulation information acquired by the manipulation information acquiring section 316, and the vehicle information acquired by the vehicle information acquiring section 318. The request determining section 420 may acquire (i) one of the voice information and the image information and (ii) at least one of the other of the voice information and the image information, the manipulation information, and the vehicle information.

The request determining section 420 executes a process to analyze the at least one of the voice information and the image information described above and recognize a specified type of request (sometimes referred to as a specific request). The request determining section 420 may reference the information stored in the setting information storage section 450 to recognize the specific request. Examples of the specific request include an activation request, a request (sometimes referred to as a stop request) for stopping or suspending the response process in the response system 112, a request concerning manipulation of the vehicle 110, and the like. Examples of the request concerning manipulation of the vehicle 110 include a request concerning manipulation or setting of the sensing section 240, a request concerning manipulation or setting of the drive section 250, a request concerning manipulation or setting of the accessory equipment 260, and the like. Examples of a request concerning setting include a request for changing a setting, a request for checking a setting, and the like.

In (a) a case where a specific request is recognized, the request determining section 420 may output information indicating the type of the recognized specific request to the executing section 430. In this way, the request determining section 420 can acquire the request indicated by at least one of the voice and a gesture of the user 20.

On the other hand, in (b) a case where a specific request is not recognized after an activation request has been recognized and a request other than a specific request is then recognized, the request determining section 420 may output to the response information generating section 440 information indicating that the request processing section 340 cannot respond to this request. Furthermore, in (c) a case where a specific request is not recognized after an activation request has been recognized and the request cannot then be recognized despite analyzing at least one of the voice information and the image information, the request determining section 420 may output information indicating that the request is unrecognizable to the response information generating section 440. The details of the request determining section 420 are described further below.

In the present embodiment, the executing section 430 acquires the information indicating the type of the recognized specific request from the request determining section 420. The executing section 430 executes a process corresponding to the type of the recognized specific request. The executing section 430 may reference the information stored in the setting information storage section 450 to determine this process. The executing section 430 outputs information indicating the execution result to the response information generating section 440, for example. The executing section 430 may output information indicating that the process has been executed to the response information generating section 440.

In the present embodiment, the response information generating section 440 determines the response to the request from the user 20. The response information generating section 440 may determine at least one of the content and the mode of the response. The response information generating section 440 may generate information (sometimes referred to as response information) indicating at least one of the determined content and mode of the response. The response information generating section 440 may output the generated response information to the response managing section 350.

Examples of the response content include the type or content of the response message to be output from the output section 220, the type or content of a command transmitted to the vehicle control section 274, and the like. In a case where one or more fixed messages are prepared as response messages, the type of the response message may be identification information for identifying each of the one or more fixed messages. The type of command may be identification information for identifying each of one or more commands that can be executed by the vehicle control section 274.

Examples of the mode of the response include the mode of the agent when the output section 220 outputs the response message, the mode of the control of the vehicle 110 by the vehicle control section 274, and the like. As described above, examples of the mode of the agent include at least one of the type of character used as the agent, the appearance of this character, the voice of this character, and the mode of the interaction. Examples of the mode of the control of the vehicle 110 include modes for restricting sudden manipulations such as sudden acceleration, sudden deceleration, sudden steering, and the like.

In the present embodiment, the setting information storage section 450 stores the various types of information relating to the setting of the request processing section 340. For example, the setting information storage section 450 stores identification information for identifying the type of the specific request and feature information indicating a feature for detecting this specific request, in association with each other. The setting information storage section 450 may store the identification information for identifying the type of the specific request, the feature information indicating a feature for detecting this specific request, and information indicating at least one of the content and the mode of the process corresponding to this specific request, in association with each other.

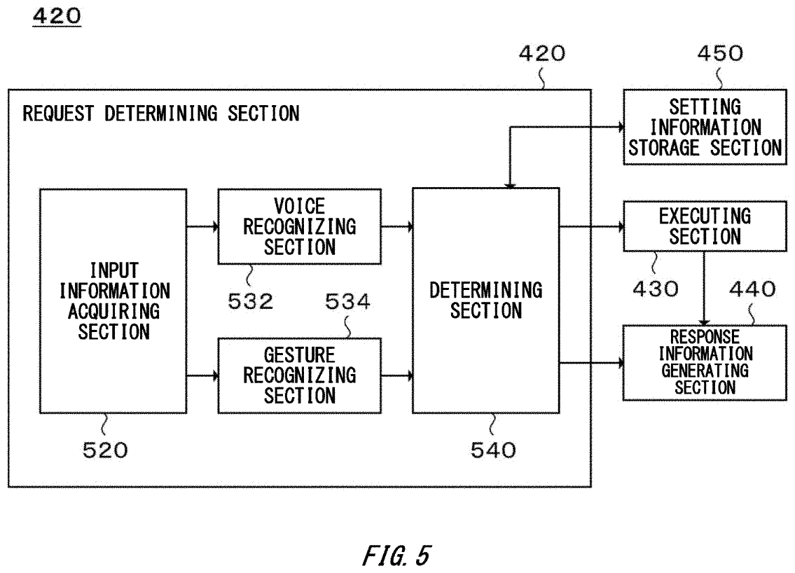

FIG. 5 schematically shows an example of an internal configuration of the request determining section 420. In the present embodiment, the request determining section 420 includes an input information acquiring section 520, a voice recognizing section 532, a gesture recognizing section 534, and a determining section 540.

In the present embodiment, the input information acquiring section 520 acquires information to be input to the request processing section 340. For example, the input information acquiring section 520 acquires at least one of the voice information acquired by the voice information acquiring section 312 and the image information acquired by the image information acquiring section 314. The input information acquiring section 520 may acquire at least one of the voice information acquired by the voice information acquiring section 312, the image information acquired by the image information acquiring section 314, the manipulation information acquired by the manipulation information acquiring section 316, and the vehicle information acquired by the vehicle information acquiring section 318. The input information acquiring section 520 may acquire (i) one of the voice information and the image information and (ii) at least one of the other of the voice information and the image information, the manipulation information, and the vehicle information.

In the present embodiment, the input information acquiring section 520 transmits the acquired voice information to the voice recognizing section 532. The input information acquiring section 520 transfers the acquired image information to the gesture recognizing section 534.

In the present embodiment, in order to facilitate understanding, the details of the request determining section 420 are described using an example of a case in which the input information acquiring section 520 acquires at least one of the voice information and the image information. However, in a case where the input information acquiring section 520 has acquired the vehicle information, the input information acquiring section 520 may transmit the vehicle information to at least one of the voice recognizing section 532 and the gesture recognizing section 534. Furthermore, in a case where the input information acquiring section 520 has acquired the manipulation information, the input information acquiring section 520 may transmit the manipulation information to the vehicle control section 274.

In the present embodiment, the voice recognizing section 532 analyzes the voice information and specifies the content of an utterance of the user 20. The voice recognizing section 532 analyzes the content of the utterance of the user 20 to recognize the request of the user 20. The voice recognizing section 532 may be set to not recognize requests other than the specific request. The voice recognizing section 532 outputs the information indicating the type of the recognized request to the determining section 540. In a case where the request cannot be recognized despite the voice information having been analyzed, the voice recognizing section 532 may output information indicating that the request is unrecognizable to the determining section 540.

In the present embodiment, the gesture recognizing section 534 analyzes the image information and extracts one or more gestures shown by the user 20. The gesture recognizing section 534 analyzes the extracted gesture to recognize the request of the user 20. The gesture recognizing section 534 may be set to not recognize requests other than the specific request. The gesture recognizing section 534 outputs the information indicating the type of the recognized request to the determining section 540. In a case where the request cannot be recognized despite the image information having been analyzed, the gesture recognizing section 534 may output information indicating that the request is unrecognizable to the determining section 540.

In the present embodiment, the determining section 540 determines whether the request identified by at least one of the voice recognizing section 532 and the gesture recognizing section 534 is a specific request. For example, the determining section 540 references the information stored in the setting information storage section 450 to determine whether the request identified by at least one of the voice recognizing section 532 and the gesture recognizing section 534 is a specific request.

In (a) a case where the request identified by at least one of the voice recognizing section 532 and the gesture recognizing section 534 is a specific request, the determining section 540 may output the information indicating the type of the recognized specific request to the executing section 430. In (b) a case where the request identified by the voice recognizing section 532 and the request identified by the gesture recognizing section 534 are not a specific request, the determining section 540 may output, to the response information generating section 440, information indicating that the request processing section 340 cannot respond to this request. In (c) a case where the voice recognizing section 532 and the gesture recognizing section 534 cannot recognize the request, the determining section 540 may output information indicating that the request is unrecognizable to the response information generating section 440.

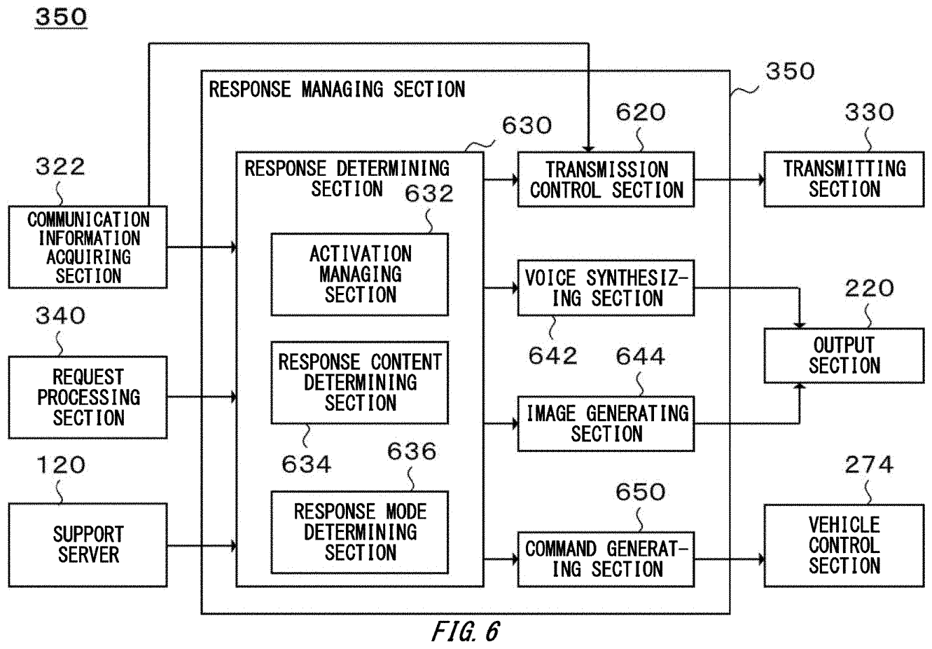

FIG. 6 schematically shows an example of an internal configuration of the response managing section 350. In the present embodiment, the response managing section 350 includes a transmission control section 620, a response determining section 630, a voice synthesizing section 642, an image generating section 644, and a command generating section 650. In the present embodiment, the response determining section 630 includes an activation managing section 632, a response content determining section 634, and a response mode determining section 636.

The transmission control section 620 may be an example of the processing apparatus determining section. The response determining section 630 may be an example of the processing apparatus determining section. The response content determining section 634 may be an example of the processing apparatus determining section. The response mode determining section 636 may be an example of the mode determining section and the processing apparatus determining section. The voice synthesizing section 642 may be an example of a voice message generating section.

In the present embodiment, the transmission control section 620 controls the operation of the transmitting section 330. The transmission control section 620 may generate a command for controlling the operation of the transmitting section 330 and transmit this command to the transmitting section 330. The transmission control section 620 may generate a command for changing a setting of the transmitting section 330 and transmit this command to the transmitting section 330.

As an example, the transmission control section 620 acquires the communication information from the communication information acquiring section 322. The transmission control section 620 generates the command described above based on the communication information. In this way, the transmission control section 620 can determine whether the response system 112 is to function as the user interface of the cloud interaction engine or of the local interaction engine, based on the communication state indicated by the communication information.

As an example, the transmission control section 620 judges the communication state to be good when the communication state indicated by the communication information satisfies a predetermined condition. On the other hand, the transmission control section 620 judges the communication state to be poor when the communication state indicated by the communication information does not satisfy this predetermined condition. Examples of the predetermined condition include a condition that communication is possible, a condition that the radio wave status is better than a specified status, a condition that the communication quality is better than a specified quality, and the like.

If the communication state is judged to be good, the transmission control section 620 generates the command described above such that the information input to the transmitting section 330 is transmitted to the support server 120 via the communicating section 230. The transmission control section 620 may generate this command such that at least one of the voice information and the image information is transmitted to the support server 120. In this way, the request from the user 20 can be processed by the cloud interaction engine.

On the other hand, if the communication state is judged to be poor, the transmission control section 620 generates the command described above such that the information input to the transmitting section 330 is transmitted to the request processing section 340. The transmission control section 620 may generate this command such that at least one of the voice information and the image information is transmitted to the request processing section 340. In this way, the request from the user 20 can be processed by the local interaction engine.

The transmission control section 620 may generate the command described above such that the information input to the transmitting section 330 is transmitted to both the support server 120 and the request processing section 340, regardless of the communication state between the vehicle 110 and the support server 120. In such a case, when the communication state between the vehicle 110 and the support server 120 is poor, the response managing section 350 cannot receive the response from the cloud interaction engine realized by the support server 120 for a prescribed interval. Therefore, as a result, the response managing section 350 uses the response from the local interaction engine that is realized by the request processing section 340 to respond to the request from the user 20.

When manipulation information has been input to the transmitting section 330, the transmission control section 620 may generate the command described above such that this manipulation is transmitted to the vehicle control section 274. In this way, the response to the manipulation of the vehicle 110 is improved.

In the present embodiment, the response determining section 630 manages the response process performed by the response system 112. For example, the response determining section 630 determines the timing at which the response process starts or ends. Furthermore, the response determining section 630 determines the response to the request from the user 20. The response determining section 630 may determine the response to the request from the user 20 based on the output from any one of the local interaction engine and the cloud interaction engine. The response determining section 630 may control the operation of the transmitting section 330 via the transmission control section 620.

In the present embodiment, the activation managing section 632 manages the timing at which the response process by the response system 112 starts or ends. The activation managing section 632 may control the transmitting section 330 according to the state of the response system 112.

[Procedure for Starting the Response Process of the Response System 112]

As an example, the activation managing section 632 starts the response process of the response system 112 according to the procedure described below. In the present embodiment, when the response system 112 is activated and transitions to the standby state, the activation managing section 632 controls the transmitting section 330 such that the request processing section 340 can detect an activation request. Specifically, the activation managing section 632 outputs information indicating that the response system 112 has transitioned to the standby state, to the transmission control section 620.

Upon acquiring the information indicating that the response system 112 has transitioned to the standby state, the transmission control section 620 transmits, to the transmitting section 330, a command instructing the transmission of at least one of the voice information and the image information to the request processing section 340. The transmission control section 620 may transmit, to the transmitting section 330, a command instructing transmission of (i) one of the voice information and the image information and (ii) at least one of the other of the voice information and the image information, the manipulation information, and the vehicle information to the request processing section 340.

Upon having the information input thereto from the transmitting section 330, the request processing section 340 analyzes at least the voice information or the image information, and starts the process for detecting the activation request from an utterance, gesture, or the like of the user 20. Upon detecting the activation request, the request processing section 340 outputs the information indicating that the activation request has been detected to the response managing section 350.

In the present embodiment, the activation managing section 632 acquires the information indicating that the activation request has been detected from the request processing section 340. In response to the detection of the activation request, the activation managing section 632 determines that the response process is to be started.

At this time, the activation managing section 632 may determine a transmission destination for at least one of the various pieces of information input to the transmitting section 330. The activation managing section 632 may determine whether the request processing section 340 is included in these transmission destinations. The activation managing section 632 may determine whether the support server 120 is included in these transmission destinations. The activation managing section 632 may acquire the communication information from the communication information acquiring section 322, and determine the transmission destination of at least one of these various pieces of information input to the transmitting section 330 based on this communication information.

As an example, if the communication state indicated by the communication information satisfies a predetermined first condition, the activation managing section 632 determines that the request processing section 340 is included as a transmission destination of the information used in the request recognition process in the request processing section 340. Examples of the first condition include (i) a case in which the communication state indicated by the communication information is worse than a predetermined first state, (ii) a case in which a parameter value or classification expressing the communication state indicated by the communication information is better than a predetermined first value or classification, and the like

While the response process is being executed by the response system 112, the activation managing section 632 may determine that the request processing section 340 is included as a transmission destination of at least one of the voice information and the image information. The information to be used in the request recognition process in the request processing section 340 may be at least one of the voice information and the image information. The information to be used in the request recognition process in the request processing section 340 may be (i) one of the voice information and the image information and (ii) at least one of the other of the voice information and the image information, the manipulation information, and the vehicle information.

As an example, if the communication state indicated by the communication information satisfies a predetermined second condition, the activation managing section 632 may determine that the support server 120 is included as a transmission destination of the information to be used in the request recognition process in the support server 120. Examples of the second condition include (i) a case in which the communication state indicated by the communication information is better than a predetermined second state, (ii) a case in which a parameter value or classification expressing the communication state indicated by the communication information is better than a predetermined second value or classification, and the like. The second state may be the same as or different from the first state.

While the response process is being executed by the response system 112, the activation managing section 632 may determine that the support server 120 is included as a transmission destination of at least one of the voice information and the image information. The information to be used in the request recognition process in the support server 120 may be at least one of the voice information and the image information. The information to be used in the request recognition process in the support server 120 may be (i) one of the voice information and the image information and (ii) at least one of the other of the voice information and the image information, the manipulation information, and the vehicle information.

The activation managing section 632 outputs information indicating that a determination has been made to start the response process to the transmission control section 620. The activation managing section 632 may output information indicating the transmission destination of each piece of information to the transmission control section 620.

Upon receiving the information indicating that the determination to start the response process has been made, the transmission control section 620 determines the transmission destination for each type of information input to the transmitting section 330. In one embodiment, the transmission control section 620 acquires the information indicating the transmission destination of each piece of information from the activation managing section 632, and determines the transmission destination of each piece of information based on this information. In another embodiment, upon acquiring the information indicating that the response process has been started, the transmission control section 620 determines the transmission destination of each piece of information according to a predetermined setting.

The transmission control section 620 transmits, to the transmitting section 330, a command instructing change of a setting relating to a transmission destination and information concerning a new setting for the transmission destination. In this way, the various types of information input to the transmitting section 330 are transmitted to the appropriate interaction engine corresponding to the communication state between the vehicle 110 and the support server 120. As a result, the response system 112 can determine which of the output of the local interaction engine and the output of the cloud interaction engine to base the response to the request from the user 20 on.

When the information is input from the transmitting section 330, the request processing section 340 starts the process for analyzing at least the voice information and the image information and recognizing the specific request from the utterance, gesture, and the like of the user 20. Upon recognizing the specific request, the request processing section 340 executes a process corresponding to the recognized specific request and outputs information concerning the response to this specific request to the response managing section 350.

When the information is input from the transmitting section 330, the support server 120 starts the process for analyzing at least the voice information and the image information and recognizing the request of the user 20 from the utterance, gesture, and the like of the user 20. Upon recognizing the request of the user 20, the request processing section 340 executes a process corresponding to the recognized request and outputs information concerning the response to this specific request to the response managing section 350.

When the process for starting the response process by the response system 112 is completed, the activation managing section 632 transmits to the user 20 an indication that the response process by the response system 112 is currently being executed, via the output section 220 and at least one of the voice synthesizing section 642 and the image generating section 644. For example, the activation managing section 632 determines that the mode of the agent is to be switched from a mode corresponding to the standby state to a mode corresponding to the response process execution state.

In the present embodiment, the details of the response managing section 350 are described using an example of a case in which the request processing section 340 detects the activation request by analyzing the voice information or image information and the response managing section 350 acquires the information indicating that the activation request has been detected from the request processing section 340. However, the response managing section 350 is not limited to the present embodiment. In another embodiment, the response managing section 350 may detect the activation request by analyzing the voice information or the image information. In yet another embodiment, the support server 120 may detect the activation request by analyzing the voice information or the image information, and the response managing section 350 may acquire the information indicating that the activation request has been detected from the support server 120.

[Procedure for Ending the Response Process of the Response System 112]

As an example, the activation managing section 632 ends the response process of the response system 112 according to the procedure described below. In one embodiment, the activation managing section 632 acquires information indicating that a stop request has been detected, from at least one of the request processing section 340 and the support server 120. When the stop request is detected, the activation managing section 632 determines that the response system 112 is to transition to the standby state. The activation managing section 632 outputs the information indicating the transition of the response system 112 to the standby state to the transmission control section 620 and the request processing section 340. The activation managing section 632 may output the information indicating the transition of the response system 112 to the standby state to the support server 120.

Upon acquiring the information indicating the transition of the response system 112 to the standby state, the transmission control section 620 transmits, to the transmitting section 330, at least one of (i) a command instructing the transmission of at least one of the voice information and the image information to the request processing section 340 and (ii) a command instructing the stoppage of the transmission of the information to the support server 120. The transmission control section 620 may transmit to the transmitting section 330 a command instructing the transmission of (i) one of the voice information and the image information and (ii) at least one of the other of the voice information and the image information, the manipulation information, and the vehicle information to the request processing section 340.

Upon acquiring the information indicating that the response system 112 is to transition to the standby state, the request processing section 340 analyzes at least the voice information or image information and starts the process for detecting the activation request from the utterance, gesture, or the like of the user 20. At this time, the request processing section 340 does not need to recognize a request other than the activation request. In this way, the computation function and power consumption of the control section 270 are suppressed.

In another embodiment, the local interaction engine and cloud interaction engine determine the activity level of the user 20 during the response process. For example, in a case where at least one of (i) the frequency at which at least one of the local interaction engine and the cloud interaction engine recognizes a request, (ii) the loudness of the voice of the user 20, and (iii) the amount of the change of a gesture of the user 20 remains in a state of being less than a predetermined value for a certain time, the local interaction engine and the cloud interaction engine determine that the activity level of the user 20 has dropped during the response process.

The activation managing section 632 acquires information indicating that the activity level of the user 20 has dropped, from at least one of the request processing section 340 and the support server 120. In a case where a drop in the activity level of the user 20 has been detected, the activation managing section 632 determines that the response system 112 is to transition to the standby mode. The activation managing section 632 may cause the response system 112 to transition to the response system 112 according to a procedure similar to the procedure of the present embodiment described above.

In the present embodiment, the response content determining section 634 determines the content of the response to the request from the user 20. The response content determining section 634 acquires the information indicating the content of the response determined by the local interaction engine from the request processing section 340. The response content determining section 634 acquires the information indicating the content of the response determined by the cloud interaction engine from the support server 120. These pieces of information are used as response candidates.

In one embodiment, in a case where the communication state between the vehicle 110 and the support server 120 is not good, for example, the response content determining section 634 cannot acquire the information indicating the content of the response determined by the cloud interaction engine from the support server 120, within a prescribed interval after the request is received. In this case, the response content determining section 634 determines the content of the response determined by the local interaction engine to be the content of the response to the request from the user 20. As a result, according to the present embodiment, the content of the response to the request from the user 20 is determined based on the communication state between the vehicle 110 and the support server 120.

In another embodiment, if the communication state between the vehicle 110 and the support server 120 is good, for example, the response content determining section 634 cannot acquire the information indicating the content of the response determined by the local interaction engine from the request processing section 340, within a prescribed interval after the request is received. In this case, the response content determining section 634 determines the content of the response determined by the cloud interaction engine to be the content of the response to the request from the user 20. As a result, according to the present embodiment, the content of the response to the request from the user 20 is determined based on the communication state between the vehicle 110 and the support server 120.

In yet another embodiment, the response content determining section 634 acquires the information indicating the content of the response determined by the cloud interaction engine and the information indicating the content of the response determined by the local interaction engine, within the prescribed period after the request is handled. In this case, the response content determining section 634 determines the content of the response determined by the cloud interaction engine, for example, to be the content of the response to the request from the user 20.

In the present embodiment, the response mode determining section 636 determines the mode of the response to the request from the user 20. The response mode determining section 636 acquires the information indicating the mode of the response determined by the local interaction engine from the request processing section 340. The response mode determining section 636 acquires the information indicating the mode of the response determined by the cloud interaction agent from the support server 120. These pieces of information are used as response candidates.

In one embodiment, in a case where the communication state between the vehicle 110 and the support server 120 is not good, for example, the response mode determining section 636 cannot acquire the information indicating the content of the response determined by the cloud interaction engine from the support server 120, within a prescribed interval after the request is received. In this case, the response mode determining section 636 determines the mode of the response determined by the local interaction engine to be the mode of the response to the request from the user 20. As a result, according to the present embodiment, the mode of the response to the request from the user 20 is determined based on the communication state between the vehicle 110 and the support server 120.

In another embodiment, in a case where the communication state between the vehicle 110 and the support server 120 is good, for example, the response mode determining section 636 cannot acquire the information indicating the mode of the response determined by the local interaction engine from the request processing section 340, within a prescribed interval after the request is received. In this case, the response mode determining section 636 determines the mode of the response determined by the cloud interaction engine to be the mode of the response to the request from the user 20. As a result, according to the present embodiment, the mode of the response to the request from the user 20 is determined based on the communication state between the vehicle 110 and the support server 120.

In yet another embodiment, the response mode determining section 636 acquires the information indicating the mode of the response determined by the local interaction engine and the information indicating the mode of the response determined by the cloud interaction engine, within a prescribed interval after the request is received. In this case, the response mode determining section 636 determines the mode of the response determined by the cloud interaction engine, for example, to be the mode of the response to the request from the user 20.

As described above, examples of the mode of the response include the mode of the agent when the output section 220 outputs the response message, the mode of the control of the vehicle 110 by the vehicle control section 274, and the like. Furthermore, examples of the mode of the agent include at least one of the type of character used as the agent, the appearance of this character, the voice of this character, and the mode of the interaction.

In one embodiment, the response mode determining section 636 determines the mode of the agent in a manner to be different between (i) a case where the response system 112 or the agent functions as the user interface of the cloud interaction engine and (ii) a case where the response system 112 or the agent functions as the user interface of the local interaction engine. As a result, the mode of the agent is determined based on the communication state between the vehicle 110 and the support server 120.

In another embodiment, the response mode determining section 636 may determine in advance the mode of the agent to be used in (i) the case where the response system 112 or the agent functions as the user interface of the cloud interaction engine and in (ii) the case where the response system 112 or the agent functions as the user interface of the local interaction engine. The response mode determining section 636 determines whether the information from the local interaction engine or the information from the cloud interaction engine is to be adopted as the response to the request from the user 20. The response mode determining section 636 switches the mode of the agent based on the result of this determination. As a result, the mode of the agent is switched based on the communication state between the vehicle 110 and the support server 120.

By suitably determining at least one of the type of the character to be used as the agent and a setting concerning this character, even when the interaction engine is switched from the cloud interaction engine to the local interaction engine and the response quality drops, worsening of the user experience can be restricted. In particular, in a case where the response system 112 is implemented in a mobile device or a portable or transportable device, the communication state changes significantly due to the movement of this device. According to the present embodiment, even in such a case, worsening of the user experience can be greatly restricted.

In one embodiment, the response mode determining section 636 may determine that the same type of character is to be used as the agent in (i) a case where the response system 112 or the agent functions as the user interface of the cloud interaction engine and in (ii) a case where the response system 112 or the agent functions as the user interface of the local interaction engine. In this case, the response mode determining section 636 may determine (i) the set age of the character used in a case where the response system 112 or the agent functions as the user interface of the cloud interaction engine to be higher than (ii) the set age of the character used in a case where the response system 112 or the agent functions as the user interface of the local interaction engine.

According to the present embodiment, when the response system 112 uses the local interaction engine that has relatively low performance capability to respond, for example, at least one of the appearance and the voice of the agent is made younger. In this way, the expectations of the user 20 are decreased. Furthermore, the feeling of discomfort experienced by the user 20 is less than in a case where a warning message is output from the output section 220. As a result, worsening of the user experience is restricted.

In another embodiment, the response mode determining section 636 may determine that an adult character is to be used as the character of the agent in (i) the case where the response system 112 or the agent functions as the user interface of the cloud interaction engine. On the other hand, the response mode determining section 636 may determine that a child character, an adolescent version of the adult character, or a character obtained by deforming the appearance of the adult character is to be used as the character of the agent in (ii) the case where the response system 112 or the agent functions as the user interface of the local interaction engine. According to the present embodiment, worsening of the user experience is restricted for the same reasons as in the case of the embodiment described above.

In another embodiment, the response mode determining section 636 may determine that an adult voice or the voice of an adult character is to be used as the voice of the agent in (i) the case where the response system 112 or the agent functions as the user interface of the cloud interaction engine. On the other hand, the response mode determining section 636 may determine that a child's voice or the voice of a child character is to be used as the voice of the agent in (ii) the case where the response system 112 or the agent functions as the user interface of the local interaction engine. According to the present embodiment, worsening of the user experience is restricted for the same reasons as in the case of the embodiment described above.

In yet another embodiment, the response mode determining section 636 may determine that different types of characters are to be used as the agent in (i) the case where the response system 112 or the agent functions as the user interface of the cloud interaction engine and in (ii) the case where the response system 112 or the agent functions as the user interface of the local interaction engine. In this case, the response mode determining section 636 determines that a character conveying a hardworking, honest, calm, composed, or adult-like impression to the user 20 is to be used as the character in (i) the case where the response system 112 or the agent functions as the user interface of the cloud interaction engine. On the other hand, the response mode determining section 636 determines that a character conveying a young, cute, childish, humorous, or likable impression is to be used as the character of the agent in (ii) the case where the response system 112 or the agent functions as the user interface of the local interaction engine. According to the present embodiment, worsening of the user experience is restricted for the same reasons as in the case of the embodiment described above.

The voice synthesizing section 642 generates a voice message responding to the request of the user 20. The voice synthesizing section 642 may generate the voice message based on the content of the response determined by the response content determining section 634 and the mode of the response determined by the response mode determining section 636. In a case where the response system 112 or the agent functions as the user interface of the local interaction engine, the voice synthesizing section 642 may generate the voice message using a predetermined fixed phrase based on the type of the request from the user 20. The voice synthesizing section 642 may output the generated voice message to the output section 220.

The image generating section 644 generates an image (sometimes referred to as a response image) responding to the request of the user 20. The image generating section 644 may generate an animated image of the agent responding to the request of the user 20. The image generating section 644 may generate the response image based on the content of the response determined by the response content determining section 634 and the mode of the response determined by the response mode determining section 636. In a case where the response system 112 or the agent functions as the user interface of the local interaction engine, the image generating section 644 may generate the response image using a predetermined image based on the type of the request from the user 20. The image generating section 644 may output the generated response image to the output section 220.

In the present embodiment, the details of the response managing section 350 are described using an example of a case in which the agent is a software agent and the image generating section 644 generates an animated image of the agent. However, the response managing section 350 is not limited to the present embodiment. In another embodiment, in a case where the agent is a hardware agent, the response managing section 350 may include a drive control section that controls driving of each section of the agent, and the drive control section may drive the agent based on the content of the response determined by the response content determining section 634 and the mode of the response determined by the response mode determining section 636.

The command generating section 650 generates a command for manipulating the vehicle 110. The command generating section 650 may determine the type of the manipulation based on the content determined by the response content determining section 634. The command generating section 650 may determine the manipulation amount or manipulation mode based on the mode of the response determined by the response mode determining section 636. The command generating section 650 may output the generated command to the vehicle control section 274.

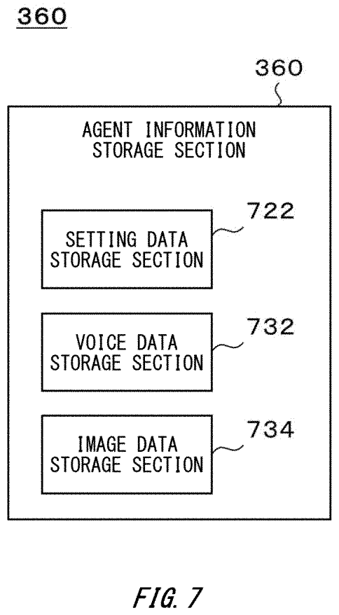

FIG. 7 schematically shows an example of the internal configuration of the agent information storage section 360. In the present embodiment, the agent information storage section 360 includes a setting data storage section 722, a voice data storage section 732, and an image data storage section 734.

In the present embodiment, the setting data storage section 722 stores the information concerning the settings of each agent. Examples of the setting include age, gender, personality, and impression to be conveyed to the user 20. In the present embodiment, the voice data storage section 732 stores information (also referred to as voice information) for synthesizing the voice of each agent. For example, the voice data storage section 732 stores data enabling a computer to read out a message with the voice of the character, for each character. In the present embodiment, the image data storage section 734 stores information for generating an image of each agent. For example, the image data storage section 734 stores data enabling a computer to dynamically generate an animated image of each character.

[Outline of Each Section of the Support Server 120]

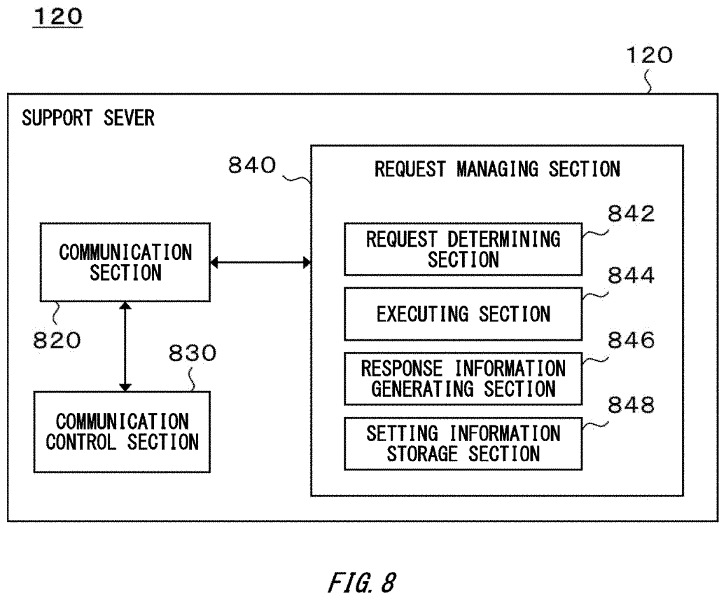

FIG. 8 schematically shows an example of the internal configuration of the support server 120. In the present embodiment, the support server 120 includes a communicating section 820, a communication control section 830, and a request processing section 840. In the present embodiment, the request processing section 840 includes a request determining section 842, an executing section 844, a response information generating section 846, and a setting information storage section 848. The request processing section 840 may be an example of the first request processing apparatus.

According to the support server 120 of the present embodiment, the cloud interaction engine is realized by cooperation between hardware and software. In the present embodiment, the communicating section 820 may have the same configuration as the communicating section 230. For example, the communicating section 820 communicates information between the support server 120 and at least one of the vehicle 110 and the communication terminal 30, via the communication network 10. In the present embodiment, the communication control section 830 may have the same configuration as the communication control section 276. For example, the communication control section 830 controls the communication between the support server 120 and an external device. The communication control section 830 may control the operation of the communicating section 820.

In the present embodiment, the request processing section 840 differs from the request processing section 340 in that the request determining section 842 realizes the cloud interaction engine. Aside from this differing point, the request processing section 840 may have the same configuration as the request processing section 340. For example, the executing section 844 may have the same configuration as the executing section 430. The response information generating section 846 may have the same configuration as the response information generating section 440. The setting information storage section 848 may have the same configuration as the setting information storage section 450.

In the present embodiment, the request determining section 842 differs from the request determining section 420 by realizing the cloud interaction engine. Aside from this differing point, the request determining section 842 may have the same configuration as the request determining section 420. The details of the request determining section 842 are described further below.

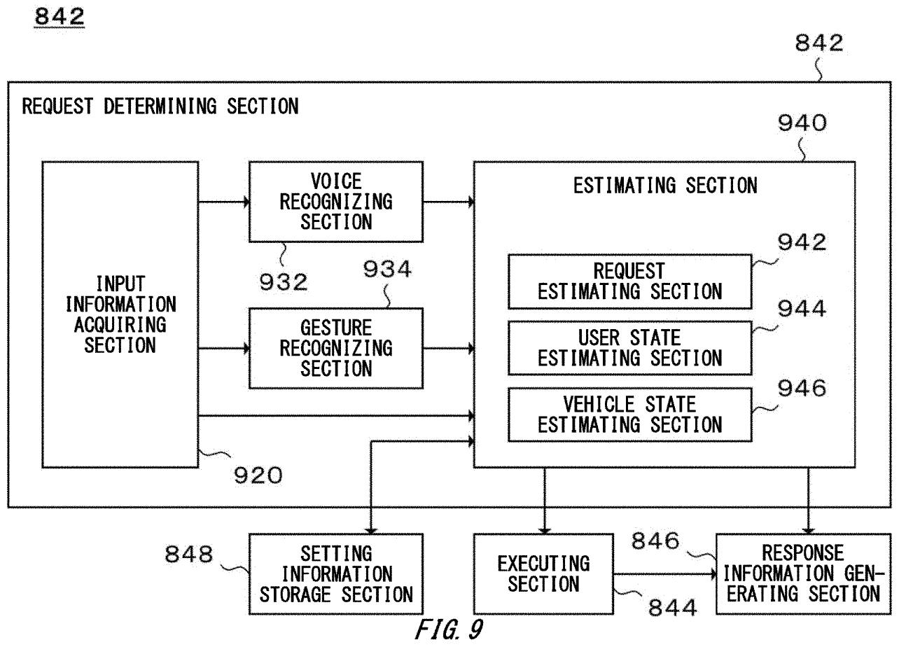

FIG. 9 schematically shows an example of the internal configuration of the request determining section 842. In the present embodiment, the request determining section 842 includes an input information acquiring section 920, a voice recognizing section 932, a gesture recognizing section 934, and an estimating section 940. In the present embodiment, the estimating section 940 includes a request estimating section 942, a user state estimating section 944, and a vehicle state estimating section 946.

The request determining section 842 differs from the request determining section 420 by including the estimating section 940 instead of the determining section 540. Aside from this differing point, the request determining section 842 may have the same configuration as the request determining section 420. For example, the input information acquiring section 920 may have the same configuration as the input information acquiring section 520. The voice recognizing section 932 may have the same configuration as the voice recognizing section 532. The gesture recognizing section 934 may have the same configuration as the gesture recognizing section 534.

In the present embodiment, the input information acquiring section 920 acquires the information to be input to the request processing section 840. For example, the input information acquiring section 920 acquires at least one of the voice information acquired by the voice information acquiring section 312 and the image information acquired by the image information acquiring section 314. The input information acquiring section 920 may acquire at least one of the voice information acquired by the voice information acquiring section 312, the image information acquired by the image information acquiring section 314, the manipulation information acquired by the manipulation information acquiring section 316, and the vehicle information acquired by the vehicle information acquiring section 318. The input information acquiring section 920 may acquire (i) one of the voice information and the image information and (ii) at least one of the other of the voice information and the image information, the manipulation information, and the vehicle information.

In the present embodiment, the input information acquiring section 920 transmits the acquired voice information to the voice recognizing section 932. The input information acquiring section 520 transmits the acquired image information to the gesture recognizing section 934. The input information acquiring section 920 transmits the acquired manipulation information to the estimating section 940. The input information acquiring section 920 transmits the acquired vehicle information to the estimating section 940. The input information acquiring section 920 may transmit at least one of the acquired manipulation information and vehicle information to at least one of the voice recognizing section 932 and the gesture recognizing section 934.

In the present embodiment, the voice recognizing section 932 analyzes the voice information and specifies the content of the utterance of the user 20. The voice recognizing section 932 outputs the information indicating the content of the utterance of the user 20 to the estimating section 940. The voice recognizing section 932 may execute a process to analyze the content of the utterance and recognize the request, but does not need to execute this process.

In the present embodiment, the gesture recognizing section 934 analyzes the image information and extracts one or more gestures shown by the user 20. The gesture recognizing section 534 outputs the information indicating the extracted gesture to the estimating section 940. The gesture recognizing section 934 may execute a process to analyze the extracted gesture and recognize the request, but does not need to execute this process.

In the present embodiment, the estimating section 940 recognizes or estimates the request from the user 20. The estimating section 940 may recognize or estimate the state of the user 20. The estimating section 940 may recognize or estimate the state of the vehicle 110.

In the present embodiment, the request estimating section 942 recognizes or estimates the request from the user 20. The request estimating section 942 may be set to be able to recognize or estimate not only the specific request, but also requests other than the specific request. In one embodiment, the request estimating section 942 acquires the information indicating the utterance of the user 20 from the voice recognizing section 932. The request estimating section 942 analyzes the content of the utterance of the user 20 and recognizes or estimates the request of the user 20. In another embodiment, the request estimating section 942 acquires the information indicating the gesture extracted by the analysis of the image information, from the gesture recognizing section 934. The request estimating section 942 analyzes the extracted gesture and recognizes or estimates the request of the user 20.

The request estimating section 942 may recognize or estimate the request from the user 20 by using information other than the voice image and the image information, in addition to the voice information or the image information. For example, the request estimating section 942 acquires at least one of the manipulation information and the vehicle information from the input information acquiring section 920. The request estimating section 942 may acquire the information indicating the state of the user 20 from the user state estimating section 944. The request estimating section 942 may acquire the information indicating the state of the vehicle 110 from the vehicle state estimating section 946. By using these pieces of information, the accuracy of the recognition or estimation by the request estimating section 942 can be improved.

The request estimating section 942 may output the information indicating the type of the recognized request to the executing section 844. In a case where the request cannot be recognized despite the analysis of the voice information or image information, the request estimating section 942 may output information indicating that the request is unrecognizable to the response information generating section 846.

In the present embodiment, the user state estimating section 944 recognizes or estimates the state of the user 20. The user state estimating section 944 recognizes or estimates the state of the user 20 based on at least one of the voice information, the image information, the manipulation information, and the vehicle information. Examples of the state of the user 20 include at least one of the psychological state, the wakefulness state, and the health state of the user 20. The user state estimating section 944 may output the information indicating the state of the user 20 to the request estimating section 942. In this way, the request estimating section 942 can narrow down the request candidates, for example, and therefore the estimation accuracy of the request estimating section 942 can be improved.

In the present embodiment, the vehicle state estimating section 946 recognizes or estimates the state of the vehicle 110. The vehicle state estimating section 946 recognizes or estimates the state of the vehicle 110 based on at least one of the voice information, the image information, the manipulation information, and the vehicle information. As described above, examples of the state of the vehicle 110 include at least one of the movement state of the vehicle 110, the operational state of each section of the vehicle 110, and the state of the internal space of the vehicle 110. The vehicle state estimating section 946 may output the information indicating the state of the vehicle 110 to the request estimating section 942. In this way, the request estimating section 942 can narrow down the request candidates, for example, and therefore the estimation accuracy of the request estimating section 942 can be improved.

[Examples of Modes of the Agent]

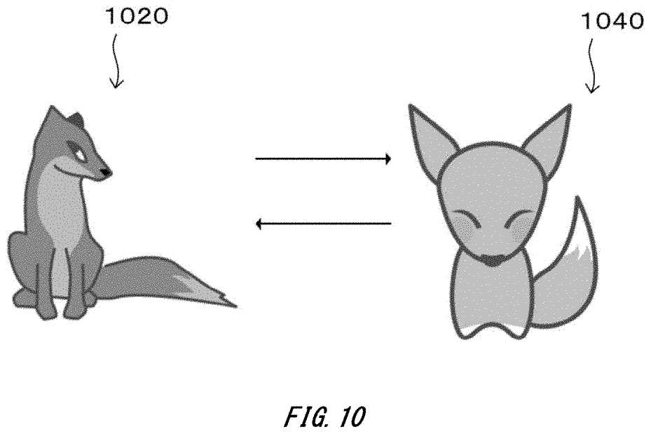

FIG. 10 schematically shows an example of a transition of the output mode of information. FIG. 10 schematically shows an example in which the appearance of the agent changes according to the state of the response system 112. In the example shown in FIG. 10, the image 1020 may be an example of an image showing the appearance of the agent in a state where the cloud interaction engine is processing the request of the user 20. The image 1040 may be an example of an image showing the appearance of the agent in a state where the local interaction engine is processing the request of the user 20.

The image 1040 may be an image in which the character drawn in the image 1020 is deformed. According to the present embodiment, the head-to-body ratio of the character in the image 1020 is less than the head-to-body ratio of the character in the image 1040. Therefore, the character drawn in the image 1040 appears younger than the character drawn in the image 1020.

According to the present embodiment, when the state of the response system 112 transitions from the state in which the cloud interaction engine processes the request of the user 20 to the state in which the local interaction engine processes the request of the user 20, the image of the agent displayed or projected by the output section 220 switches from the image 1020 to the image 1040. Similarly, when the state of the response system 112 transitions from the state in which the local interaction engine processes the request of the user 20 to the state in which the cloud interaction engine processes the request of the user 20, the image of the agent displayed or projected by the output section 220 switches from the image 1040 to the image 1020.

According to the present embodiment, the user 20 can understand the transition of the interaction engine using their senses. Furthermore, since the age set for the character drawn in the image 1040 corresponding to the local interaction engine is less than the age set for the character drawn in the image 1020 corresponding to the cloud interaction engine, when the local interaction engine is processing the requests of the user 20, the expectations that the user 20 has for the interaction engine are lowered. As a result, worsening of the user experience of the user 20 can be restricted.

While the embodiments of the present invention have been described, the technical scope of the invention is not limited to the above described embodiments. It is apparent to persons skilled in the art that various alterations and improvements can be added to the above-described embodiments. The features described in certain embodiments can be applied in other embodiments, as long as this does not result in a technical contradiction. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### LIST OF REFERENCE NUMERALS

10: communication network, 20: user, 30: communication terminal, 100: interactive agent system, 110: vehicle, 112: response system, 114: communication system, 120: support server, 210: input section, 220: output section, 230: communicating section, 240: sensing section, 250: drive section, 260: accessory equipment, 270: control section, 272: input/output control section, 274: vehicle control section, 276: communication control section, 312: voice information acquiring section, 314: image information acquiring section, 316: manipulation information acquiring section, 318: vehicle information acquiring section, 322: communication information acquiring section, 330: transmitting section, 340: request processing section, 350: response managing section, 360: agent information storage section, 420: request determining section, 430: executing section, 440: response information generating section, 450: setting information storage section, 520: input information acquiring section, 532: voice recognizing section, 534: gesture recognizing section, 540: determining section, 620: transmission control section, 630: response determining section, 632: activation managing section, 634: response content determining section, 636: response mode determining section, 642: voice synthesizing section, 644: image generating section, 650: command generating section, 722: setting data storage section, 732: voice data storage section, 734: image data storage section, 820: communicating section, 830: communication control section, 840: request processing section, 842: request determining section, 844: executing section, 846: response information generating section, 848: setting information storage section, 920: input information acquiring section, 932: voice recognizing section, 934: gesture recognizing section, 940: estimating section, 942: request estimating section, 944: user state estimating section, 946: vehicle state estimating section, 1020: image, 1040: image

What is claimed is:

1. A control apparatus that controls an agent apparatus functioning as a user interface of a first request processing apparatus that acquires a request indicated by at least one of a voice and a gesture of a user, via a communication network, and performs a process corresponding to the request, the control apparatus comprising:
a communication information acquiring section that acquires communication information indicating a communication state between the first request processing apparatus and the agent apparatus; and
a mode determining section that determines a mode of an agent used to provide information by the agent apparatus, based on the communication state indicated by the communication information acquired by the communication information acquiring section.

2. The control apparatus according to claim 1, wherein
the mode of the agent is at least one of (i) a type of character used as the agent, (ii) an appearance of the character, (iii) a voice of the character, and (iv) a mode of an interaction of the character.

3. The control apparatus according to claim 1, wherein
the agent apparatus further functions as a user interface of a second request processing apparatus that is different from the first request processing apparatus,
the second request processing apparatus acquires a request indicated by a voice or a gesture of the user from the agent apparatus, via wired communication or short range wireless communication, and performs a process corresponding to the request, and
the control apparatus further comprises a processing apparatus determining section that determines whether the agent apparatus is to function as the user interface of the first request processing apparatus or the second request processing apparatus, based on the communication state indicated by the communication information acquired by the communication information acquiring section.

4. The control apparatus according to claim 3, wherein
the mode determining section determines the mode of the agent such that the mode of the agent differs between (i) a case in which the agent apparatus is determined to function as the user interface of the first request processing apparatus and (ii) a case in which the agent apparatus is determined to function as the user interface of the second request processing apparatus.

5. The control apparatus according to claim 3, wherein
the mode determining section determines in advance (i) the mode of the agent in a case where the agent apparatus is to function as the user interface of the first request processing apparatus and (ii) the mode of the agent in a case where the agent apparatus is to function as the user interface of the second request processing apparatus, and
the mode determining section switches the mode of the agent based on a determination result of the processing apparatus determining section.

6. The control apparatus according to claim 3, wherein
the mode determining section determines that the same type of character is to be used in (i) a case where the agent apparatus is to function as the user interface of the first request processing apparatus and (ii) a case where the agent apparatus is to function as the user interface of the second request processing apparatus, and
the mode determining section determines that (i) a set age of the character used in a case where the agent apparatus is to function as the user interface of the first request processing apparatus is higher than (ii) a set age of the character used in a case where the agent apparatus is to function as the user interface of the second request processing apparatus.

7. The control apparatus according to claim 3, wherein
the mode determining section determines that an adult character is to be used as the character of the agent in (i) a case where the agent apparatus functions as a user interface of the first request processing apparatus, and
the mode determining section determines that a child character, a character that is a young version of the adult character, or a character obtained by deforming the appearance of the adult character is to be used as the character of the agent in (ii) a case where the agent apparatus functions as a user interface of the second request processing apparatus.

8. The control apparatus according to claim 3, wherein
the mode determining section determines that a voice of an adult or a voice of an adult character is to be used as the voice of the agent in (i) a case where the agent apparatus functions as a user interface of the first request processing apparatus, and
the mode determining section determines that a voice of a child or a voice of a child character is to be used as the voice of the agent in (ii) a case where the agent apparatus functions as a user interface of the second request processing apparatus.

9. The control apparatus according to claim 3, further comprising:
a voice message generating section that generates a voice message responding to the request of the user, wherein
the voice message generating section generates the voice message using a fixed phrase that is determined based on a type of the request, in a case where the agent apparatus functions as the user interface of the second request processing apparatus.

10. The control apparatus according to claim 3, wherein
the number of types of requests that can be recognized by the second request processing apparatus is less than the number of types of requests that can be recognized by the first request processing apparatus.

11. The control apparatus according to claim 3, wherein
the number of types of requests that can be processed by the second request processing apparatus is less than the number of types of requests that can be processed by the first request processing apparatus.

12. The control apparatus according to claim 1, wherein
the agent apparatus is an interactive vehicle driving support apparatus.

13. An agent apparatus functioning as a user interface of a request processing apparatus that acquires a request indicated by at least one of a voice and a gesture of a user and performs a process corresponding to the request, the agent apparatus comprising:
the control apparatus according to claim 1, and
an agent output section that displays or projects an image of the agent, according to the mode determined by the mode determining section of the control apparatus.

14. The agent apparatus according to claim 13, further comprising:
an input section that inputs information indicating at least one of a voice and a gesture of the user; and
a voice message output section that outputs a voice message to the user.

15. A non-transitory computer readable storage medium storing thereon a program that causes a computer to function as a control apparatus that controls an agent apparatus functioning as a user interface of a first request processing apparatus that acquires a request indicated by at least one of a voice and a gesture of a user, via a communication network, and performs a process corresponding to the request, the control apparatus comprising:
a communication information acquiring section that acquires communication information indicating a communication state between the first request processing apparatus and the agent apparatus; and
a mode determining section that determines a mode of an agent used to provide information by the agent apparatus, based on the communication state indicated by the communication information acquired by the communication information acquiring section.
